(19) United States
(12) Patent Application Publication
(10) Pub. No.: US 2009/0254902 A1
(43) Pub. Date: Oct. 8, 2009

(54) METHOD FOR IMPROVING ACCESS EFFICIENCY OF SMALL COMPUTER SYSTEM INTERFACE STORAGE DEVICE

(75) Inventors: Yong-Hai Chen, Tianjin (CN); Tom Chen, Taipei (TW); Win-Harn Liu, Taipei (TW)

Correspondence Address: Workman Nydegger;1000 Eagle Gate Tower, 60 East South Temple, Salt Lake City, UT, 84111, US

(73) Assignee: INVENTEC CORPORATION, Taipei (TW)

(21) Appl. No.: 12/061,529

(22) Filed: Apr. 2, 2008

(51) Int. Cl. G06F 9/46

(52) U.S. Cl. 718/100

(57) ABSTRACT

A method for improving an access efficiency of a small computer system interface (SCSI) storage device is used to process a plurality of access requests for a physical storage device from a request end. The task processing method includes setting a task queue in each virtual disk, for receiving a plurality of disk access tasks sent from a server; writing the disk access tasks to storage addresses in the virtual disk; executing a storage address recording, for recording the disk access tasks having the same storage address, and sending the rest disk access tasks in sequence to the physical storage device; saving the disk access tasks into a request queue of the physical storage device; executing a program sequence optimization on the disk access tasks in the request queue; and sending back the disk access tasks after the program optimization process to the virtual disk.

### BACKGROUND OF THE INVENTION

1. Field of Invention

The present invention relates to a method for accessing a storage device, and more particularly, to a method for improving an access efficiency of a small computer system interface (SCSI) storage device.

2. Related Art

As network speed quickly develops, storage devices begin to change from a single unit storage manner to a network device storage manner. In a network storage system, a network storage interface combining the SCSI and network transmission exists, which is referred to as Internet SCSI (iSCSI).

In iSCSI protocol, corresponding rule and method for sending and receiving storage data of data blocks in TCP/IP network are defined. An initiator packages the SCSI commands and data into a packet and relays the packet through the network. Next, after receiving the packet, a target restores and executes the SCSI commands and the data. After finishing the command, the target packages the returned SCSI commands and data into a packet again and sends back the packet to the initiator.

In the iSCSI, a corresponding logic unit number (LUN) is respectively given to the storage device. Generally speaking, the number of the storage devices loaded on an SCSI bus is limited. Usually, the number of the storage devices is 6 or 15. In order to recognize the storage devices, a target ID is adopted for representing the corresponding storage device. As long as the storage device is added into the server, a corresponding code number is given by the server.

In recent iSCSI architecture, an implementation layer of the SCSI virtual disk is provided, for serving as interface conversion. In order to ensure the completeness of the data during transmission, following implementation manners are provided for performing the synchronous serial SCSI task.

First Manner:

A queue is provided in the server, for saving tasks to be executed for all the virtual disk devices. The server read the tasks in the queue in turn by a plurality of threads, and then sends the read tasks to corresponding layers of the iSCSI for execution. The tasks are, for example, saving on the storage devices, reading on data blocks, and other tasks. For each thread, the read/write processes on the storage devices are totally synchronous. Each task is processed in sequence by a serial manner. A multi-thread processing method is adopted, so the task executing sequence on the same device may be reversed. If the reversely executed tasks read and write the same region, the data will not be complete. The frequent context switching among a plurality of inner core threads may partially neutralize the performance improvement caused by the multi-threads. When a plurality of LUN single queues exists when the network transmission is frequent, the commands on certain LUNs might not be executed on real time.

Second Manner:

A queue is set in each virtual disk device. When receiving a disk read/write task, the virtual disk device firstly saves the task in the queue for waiting, until the preceding tasks in the queue are processed. In other words, in one virtual disk device, only one task can be executed at a time. The advantage is that it is ensured that each task will be executed according to the sequence, thereby ensuring the completeness of the written data. However, the writing is serially performed in sequence, so the writing speed of the physical storage device will be greatly reduced, such that the writing spirit departs from the original using intention of the SCSI.

### SUMMARY OF THE INVENTION

In view of the above problem, the present invention is mainly directed to provide a method for improving the access efficiency of a small computer system interface (SCSI) storage device, for processing a plurality of access requests for a physical storage device from a request end.

In order to achieve the objective, the method for improving an access efficiency of a SCSI storage device provided by the present invention includes firstly sending a plurality of access requests from a request end to a server; the server dispatching a corresponding disk access task to each virtual disk according to the access requests; setting a task queue in each virtual disk, for receiving a plurality of disk access tasks sent from a server; writing the disk access tasks into storage addresses in the virtual disk; executing a storage address recording means, for recording the disk access tasks having the same storage address, and sending the rest disk access tasks in sequence to the physical storage device; saving the disk access tasks into a request queue of the physical storage device; executing a program sequence optimization means on the disk access tasks in the request queue, for re-adjusting a executing sequence of the disk access tasks; sending back the disk access tasks after the program optimization process to the virtual disk.

The present invention provides a method for improving an access efficiency of an SCSI storage device, thereby solving the problem that the data is not complete due to overlapped access task addresses and the problem of low data writing speed in the task queue. In the present invention, the method for accelerating the access task of the physical storage device of the SCSI can perform an asynchronous process on the physical storage device.

### BRIEF DESCRIPTION OF THE DRAWINGS

The present invention will become more fully understood from the detailed description given herein below for illustration only, and thus are not limitative of the present invention, and wherein:

FIG. 1 is a schematic view of the system architecture of the present invention;

FIG. 2 is a schematic view of the operation procedure of the present invention; and

FIG. 3 is a schematic view of the transmission of the disk access task and the virtual disk of the present invention.

### DETAILED DESCRIPTION OF THE INVENTION

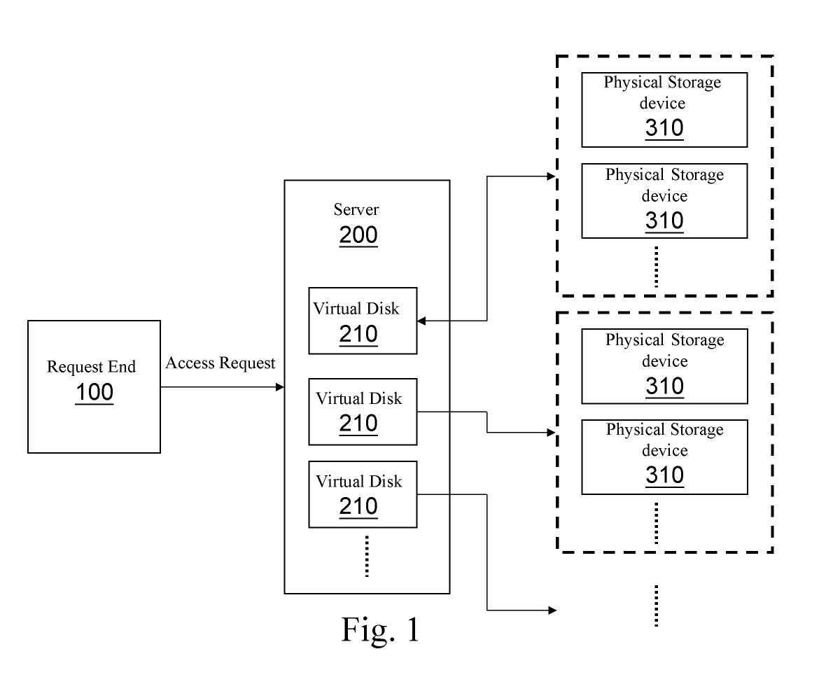

The present invention provides a method for improving an access efficiency of an SCSI storage device. Referring to FIG. 1, a schematic view of the system architecture of the present invention is shown. For realizing asynchronous processing on the virtual disk in the SCSI, a request end 100, a server 200, and physical storage devices 310 are required. A virtual disk management program is executed on the server 200. The virtual disk management program integrates the plurality of physical storage devices 310 into a virtual disk 210, for the request end 100 to access, such that it is not necessary for the request end 100 to dispatching the data to different physical storage devices 310.

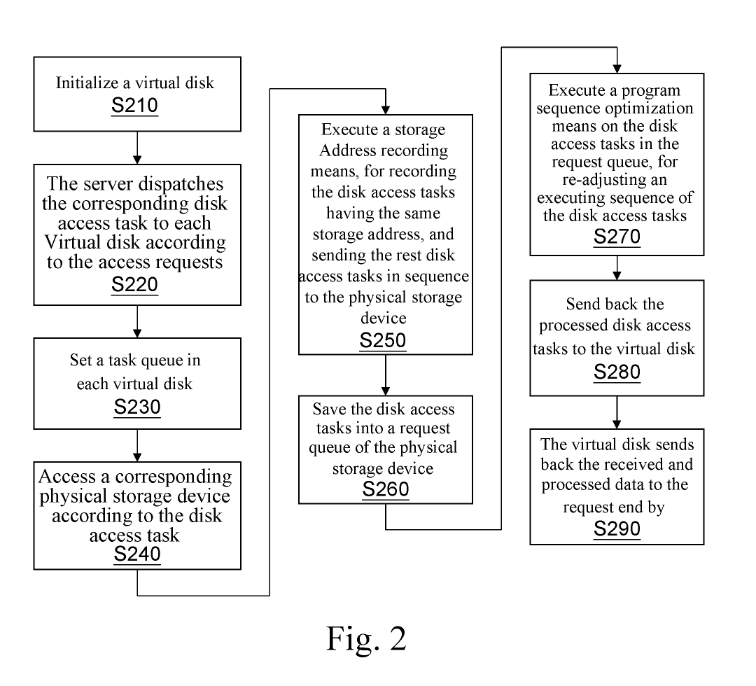

For the executing sequence of the plurality of access tasks of the virtual disk applied to the SCSI, please refer to FIG. 2, a schematic view of the operation procedure of the present invention is shown. The method for improving the access efficiency of the SCSI storage device includes firstly the request end 100 sending a plurality of access requests to the server 200. In the server, the virtual disks are initialized (step S210), and the virtual disks 210 are used to dispatch the access requests to the corresponding physical storage devices 310. The server dispatches the corresponding disk access task to each virtual disk according to the access requests (step S220).

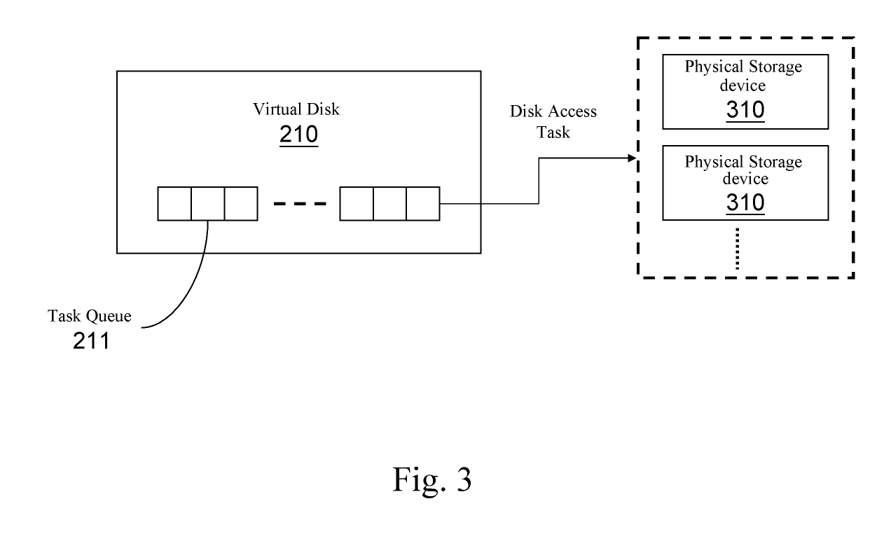

A task queue is set in each virtual disk (step S230), and the task queue 211 is used to receive the disk access tasks sent from the server 200. In the present invention, the disk access task refers to the access instruction performing the read/write action on the physical storage device 310. For the management instruction not requiring the disk read/write operation, the server 200 may sends it back to the request end 100 according to stored information. In addition, referring to FIG. 3, a schematic view of the transmission of the disk access task and the virtual disk of the present invention is shown.

The corresponding physical storage device is accessed according to the disk access task (step S240). A storage address recording means is executed, for recording the disk access task having the same storage address, and sending the rest disk access tasks in sequence to the physical storage device (step S250). When the virtual disk 210 receives the disk access task having the same storage address as the physical storage device 310, the server 200 saves the disk access task into the waiting queue and sets the disk access task in a waiting state. After the disk access task executed in the physical storage device 310 is finished, and the server 200 is informed, the server 200 sends the disk access task to the physical storage device 310.

In order to count the disk access tasks having the same storage address in statistics and search the disk access tasks having the same storage address, in practical program, three data members, namely, wait_list, wait_queue, and wait_count are added into the data structure of the disk access task, and the data structure thereof is shown below.

struct wait_task_adress
{
struct list_head wait_list;
struct ist_task_t *wait_task;
};
struct ist_task_t
{
struct list_head list;
....
struct list_head wait_queue;
u32 wait_count;
};

After a first disk access task is received, firstly it is checked whether the request queue has the disk access task having the address overlapping that of the first disk access task. If the request queue has a second access task having the same storage address as the first access task, the address of the first access task is saved in the wait_task_address structure, and the wait_list is set in the wait_queue of the second access task. At the same time, 1 is added to the wait_count in the first access task structure. After the first access task is executed, the wait_list of the second access task is found out from the wait_task adress on the wait_queue of the first access task. The wait_list of the second access task is removed from the wait_queue of the first task, and 1 is subtracted from the wait_count of the first access task.

The disk access task is saved into the request queue of the physical storage device (step S260). A program sequence optimization means is executed on the disk access tasks in the request queue, for re-adjusting the executing sequence of the disk access tasks (step S270). For the disk access tasks in the request queue, the physical storage device 310 can sort the disk access tasks with the same or similar types in sequence according to exchange sort method, selection sort method, insertion sort method, merge sort method, and quick sort method, thereby accelerating the access speed of the physical storage device 310. The processed disk access task is sent back to the virtual disk (step S280). The physical storage device 310 invokes the registered callback function, so as to send back the execution result and the disk access task context to the virtual disk 210. Finally, the virtual disk sends back the received and processed data to the request end (step S290).

In addition, if the request queue still has the disk access task, it is searched whether the corresponding disk access task being executed exists in the physical storage device 310, according to the storage address of the disk access task in the request queue. If the physical storage device 310 still has the disk access task being executed at the same storing position, the disk access task in the request queue is still maintained in the request queue. If the physical storage device 310 does not have the disk access task being executed at the same storing position, the disk access task in the request queue is sent to the physical storage device 310 for execution.

The present invention provides a method for improving the access efficiency of the SCSI storage device, thereby solving the problem that the data is not complete due to overlapped access task address and the problem of low data writing speed in the task queue 211. In the present invention, the method for accelerating the access task of the physical storage device 310 of the SCSI can perform an asynchronous process on the physical storage device 310.

What is claimed is:

1. A method for improving an access efficiency of a small computer system interface (SCSI) storage device, for processing a plurality of access requests for a physical storage device from a request end, comprising:
initializing a virtual disk, for dispatching the access requests to the corresponding physical storage device;
setting a task queue in each virtual disk, for receiving a plurality of disk access tasks sent from a server;
accessing a corresponding physical storage device according to the disk access tasks;
executing a storage address recording means, for recording the disk access task having a same storage address, and sending the rest disk access tasks in sequence to the physical storage device;
saving the disk access tasks into a request queue of the physical storage device;
executing a program sequence optimization means on the disk access tasks in the request queue, for re-adjusting an executing sequence of the disk access tasks;
sending back the processed disk access tasks to the virtual disk; and
sending back data of the corresponding access request to the request end.

2. The method for improving an access efficiency of a SCSI storage device as claimed in claim 1, wherein the step of executing a storage address recording means further comprises:
saving the disk access tasks having the same storage address in a waiting queue;
waiting for finish of the execution of the disk access tasks having the same storage address of the physical storage device; and
sending the disk access tasks in sequence to the physical storage device.

3. The method for improving an access efficiency of a SCSI storage device as claimed in claim 1, wherein the SCSI comprises an Internet SCSI.

4. The method for improving an access efficiency of a SCSI storage device as claimed in claim 1, wherein the step of sending back the processed disk access tasks to the virtual disk further comprises:
invoking a registered callback function to send back an execution result and a context of the disk access task to the virtual disk.

5. The method for improving an access efficiency of a SCSI storage device as claimed in claim 1, wherein the program execution optimization means is an exchange sort method, a selection sort method, an insertion sort method, a merge sort method, and a quick sort method.
